(19) United States
(12) Patent Application Publication
(10) Pub. No.: US 2018/0323556 A1
(43) Pub. Date: Nov. 8, 2018

(54) Multipolar Connector

(71) Applicant: Fischer Connectors Holding SA, Saint-Prex (CH)

(72) Inventors: Savino Storione, Saint-Prex (CH); Nicolas Convert, Saint-Prex (CH); Jean-Marie Buchilly, Saint-Prex (CH)

(21) Appl. No.: 15/769,392

(22) PCT Filed: Oct. 13, 2016
(86) PCT No.: PCT/IB2016/056139

§ 371 Date: Apr. 19, 2018

(30) Foreign Application Priority Data
Oct. 27, 2015 (IB) PCT/IB2015/058257
Apr. 21, 2016 (IB) PCT/IB2016/052275

(51) Int. Cl. H01R 24/38; H01R 13/24; H01R 13/52; H01R 13/627; H01R 35/04

(52) U.S. Cl. CPC H01R 24/38; H01R 13/24; H01R 35/04; H01R 13/5219; H01R 13/6276; H01R 13/521

(57) ABSTRACT

Connector comprising a base (1) of substantially cylindrical form and a plug (2), connectable to the base in a removable manner to the base (2), in which are disposed a plurality of contacts (3); the base (1) comprising a conducting face (4) on or in which is disposed at least one conducting track (5) forming at least one arc of a circle whose centre (6) is substantially coincident with the centre of the conducting face (4); said track (5) furthermore being disposed in such a way as to permit a mechanical electrical coupling with one of said contacts (3).

### FIELD OF THE INVENTION

The present invention relates to connectors, in particular electrical connectors.

### STATE OF THE ART

In most cases, the use of a multipole connector requires the two main components (e.g. one component containing male contacts and one component with female contacts) to be fixed to one another according to a specific angular orientation.

The fact of having to align one component relative to the other, prior to connection, constitutes a nuisance. There is therefore a need to be able to eliminate this nuisance.

### GENERAL DESCRIPTION OF THE INVENTION

The invention proper consists of a connector comprising a socket of substantially cylindrical form and a plug, that can be removably connected to the socket, in which there are arranged a plurality of contacts. The socket comprises a conductive face in the form of a disk on or in which there is arranged at least one conductive track forming at least one circular arc whose center substantially coincides with the center of the conductive face, said track being also arranged so as to allow a mechanical electrical coupling with one of said contacts.

In the connector according to the invention, the socket and the plug constitute the two main components which form the connector.

In the particular configuration which comprises only a single circular track, the center of the face of the socket is a conductive disk, which is arranged so as to allow an electrical coupling with a contact of the plug arranged at the center thereof.

Preferably, the connector comprises at least two circular conductive tracks which are arranged concentrically.

Advantageously, each contact of the plug is mounted to be axially mobile, independently of the other contacts, in order to ensure a permanent mechanical contact with the conductive tracks of the socket.

A mechanism can be provided to exert a return force on each contact.

According to a variant of the invention, the contacts are arranged through a flexible membrane, for example made of rubber, which is preferably seal-tight.

The plug, overall, can be oriented in a single direction. Alternatively, it can be bent.

The plug can be connected to be free to rotate about the socket, or according to a limited number of angular orientations.

### DETAILED DESCRIPTION OF THE INVENTION

The invention will be better understood from the following description which in particular contains a few illustrated examples.

### BRIEF DESCRIPTION OF THE FIGURES

FIG. 1 represents a variant of the invention with a socket designed for a free orientation of the plug.

FIG. 2 represents another variant of the invention with a socket designed for limited angular orientations of the plug.

FIG. 3 represents a side view of the socket.

FIG. 4 represents a cross-sectional view of a socket.

FIG. 5 represents a plug (bent)-socket pair connected together.

FIG. 6 represents another view of a bent plug.

FIG. 7 shows the wiring of a plug.

FIG. 8 represents a plug comprising several outputs.

FIG. 9 represents a stack of plugs/sockets.

FIG. 10 represents a spring ring.

FIG. 11 represents the incorporation of a spring ring in a plug.

### NUMERIC REFERENCES USED IN THE FIGURES

1. Socket

2. Plug

3. Contact

4. Conductive face

5. Conductive track

6. Center of the conductive face

7. Nut

8. Contact

9. Membrane

10. Output

11. Spring ring

12. Ball

13. Circular groove

14. Ball housing

According to the embodiment illustrated in the present document, the connector comprises seven contacts.

It goes without saying that the invention is not limited to this configuration. It also covers all the connectors comprising at least two contacts.

Likewise, the dimensions of the connector according to the invention can be any dimensions.

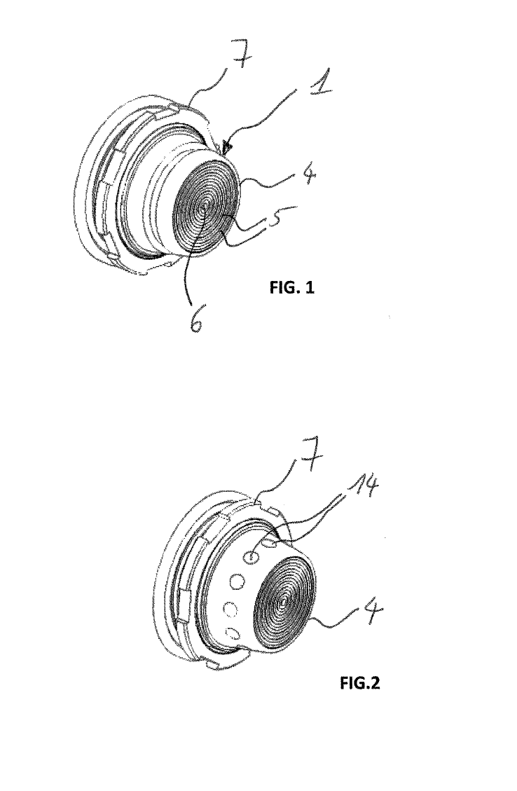

The connector according to the invention has the particular feature of not requiring prior orientation of the plug 2 (e.g. a wired element) relative to the socket 1 (e.g. a unit housing element). This advantage results from the cylindrical/circular geometry of the socket and of its conductive face 4 (see for example FIG. 1). Once connected, the relative rotation between the socket 1 and the plug 2 can be free or blocked via a bistable-type system, for example a locking by lateral pressure and unlocking by axial pressure).

An orientation can nevertheless be given and limit the plugging-in possibilities to a finite number of different angular positions (e.g. four positions separated by 90° or 12 positions separated by 30°) as described in FIG. 2.

The socket 1 is composed of a body that can be fixed onto an external device via a fixing element such as a nut 7 (FIG. 1) or rivets or any other suitable means making it possible to durably fix these two elements (e.g.: socket sewn onto a fabric/clothing item).

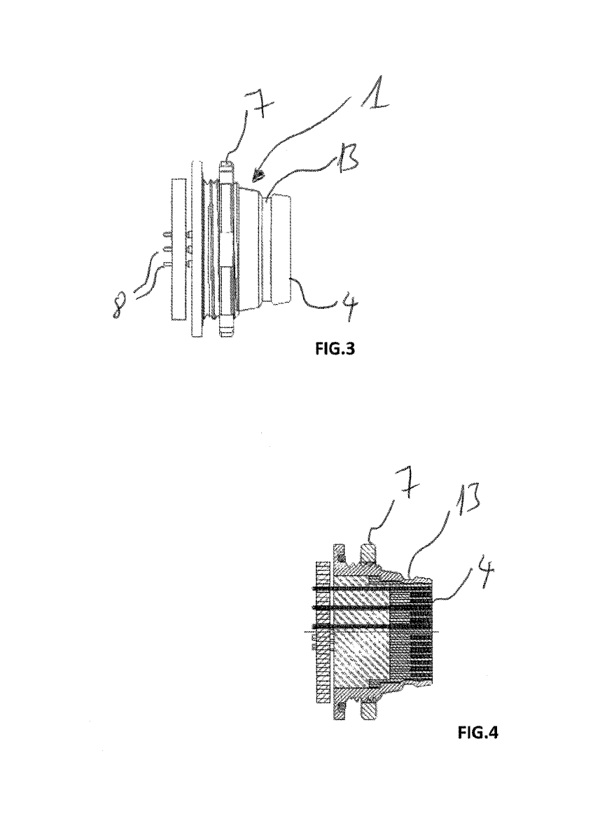

The socket 1 can be connected to the device via metallic contacts 8 which interconnect directly with the device (that can be a fabric incorporating conductive parts incorporated or not in the fabric) or through an electrical circuit (PCB, flex, etc.) welded to the socket and interfacing with the device (FIG. 3).

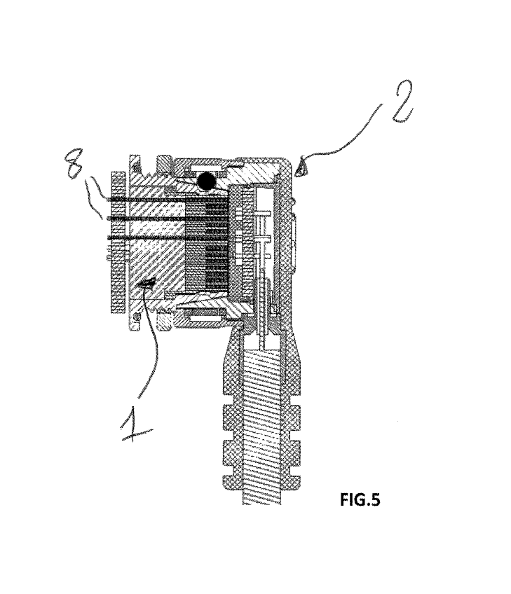

The plug 2 is composed of electrically conductive parts separated by electrically insulating parts. It can be composed of any type of assembly of parts making it possible to ensure the function of signal transmission and of electrical insulation (FIG. 1 and FIG. 4). The plug 2 and the socket 1 are preferably “cleanable” in as much as it is easy to access the surface in order to eliminate dirt/deposits/particles without a specific cleaning tool.

Advantageously, the plug 2 connects to and disconnects from the socket 1 by a single hand.

The connection/disconnection can be performed by simple pressure/pulling force on the plug 2 (variant without locking) (FIG. 5). According to another variant, the connector comprises a locking and a lateral pressure on the two sides (or any other deliberate action) is necessary in order to free the locking mechanism.

Preferably, the plug 2 should exhibit a certain elasticity in order to guarantee the electrical contact with the socket 1. To this end, each contact 3 can be mounted to be axially mobile independently of the other contacts 3 in order to guarantee that each contact 3 is pressed onto the corresponding track 5 of the socket 1. Advantageously, the contacts 3 pass through a flexible membrane 9, obtained for example by overmolding a rubber over the contacts 3 or any other means in order to constitute a subassembly allowing the individual mobility of the contacts 3 relative to one another (FIG. 5).

The membrane 9 also makes it possible to guarantee the seal-tightness of the assembly.

An elastic element (not represented in the illustrations), inducing a return mechanism toward the socket 1, makes it possible to exert an individual pressure on each contact 3 in order to guarantee the electrical continuity on each contact 3. It should be noted that the membrane 9 can exert this elastic element function.

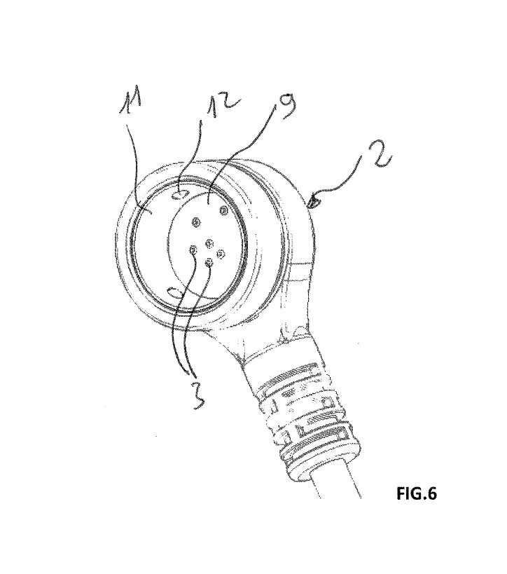

The quasi-smooth surface of the membrane 9 and of the contacts 3 makes it possible to also guarantee a perfect “cleanability”, similar to that of the socket 1 (FIG. 6).

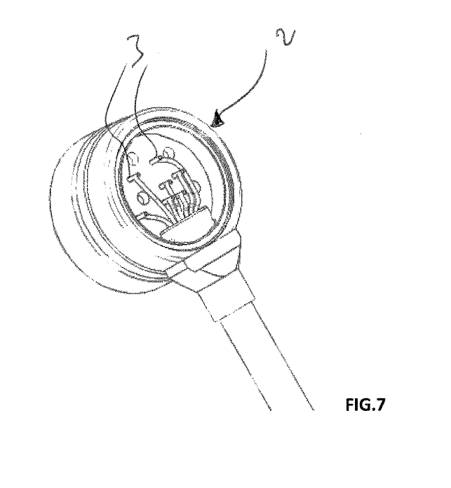

The wires of the cables or any other link means, e.g. PCB (not illustrated), are connected (e.g. horizontally welded) onto the rear face of each contact 3 in order to guarantee the electrical link while limiting the bulk. A cap covers the assembly in order to mechanically protect the system and render it seal-tight (FIG. 7).

According to another variant (not illustrated) of the invention, the concentric tracks form circular grooves in the face of the socket.

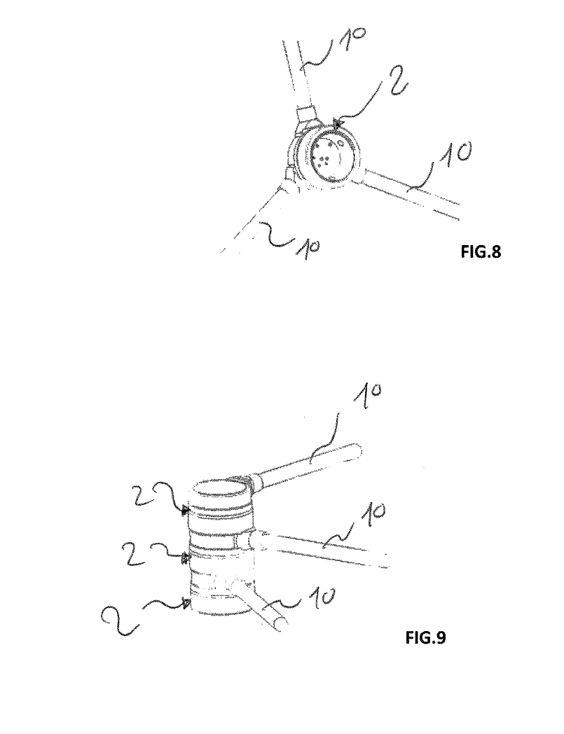

The number of outputs 10 of the plug 2 and of the socket 1 can be multiple (FIG. 8).

The plug 2 can include a “socket” part in order to allow a stacking of several plugs/sockets (FIG. 9).

The locking and/or the acknowledgement of plugging-in of the connector can be produced by means of a spring ring 11 exhibiting a certain elasticity, the ring 11 bearing on balls 12 which have themselves come to be housed in a groove 13 formed on the socket (FIGS. 1 and 3).

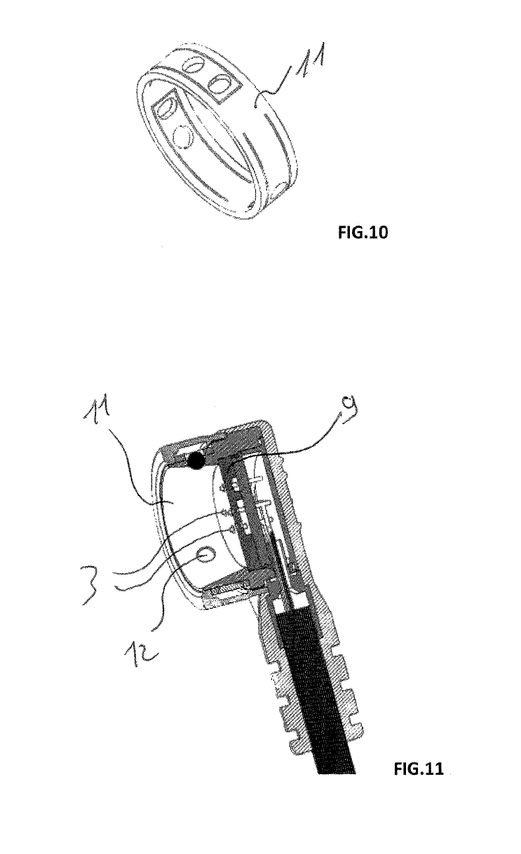

A possible illustration of the spring ring 11 is illustrated in FIG. 10 and its incorporation in the plug 2 is illustrated in FIG. 11.

The position of the ball housings 14 (FIG. 2) can be multiple and offer several locking points in order to avoid the rotation once plugged in.

1-9. (canceled)

10. A connector comprising:
a socket of substantially cylindrical form having a rotation axis, the socket including a face having a plurality of conductive tracks forming circular arcs, each arc having a center that substantially coincides with the rotation axis of the socket; and
a plug configured to be removably connected to the socket, the plug including,
a plurality of contacts, at least one of the plurality of contacts configured for mechanical electrical coupling with a corresponding one of the plurality of conductive tracks, each one of the plurality of contacts configured to be axially mobile independently of the other contacts,
a flexible membrane that is traversed by the plurality of contacts, the flexible membrane being seal-tight and configured to exert an individual pressure on each one of the plurality of contacts as a return mechanism towards the socket, and
a mechanism exerting a return force on each one of the plurality of contacts.

11. The connector as claimed in claim 10, wherein at least two of the plurality of conductive tracks are arranged concentrically.

12. The connector as claimed in claim 10, wherein the plug has a bent shape.

13. The connector as claimed in claim 10, wherein the plug is configured to connect to the socket to rotate about the socket.

14. The connector as claimed in claim 10, wherein the plug is configured to connect to the socket according to a limited number of orientations about the socket.

15. The connector as claimed in claim 10, wherein the plurality of contacts are distributed asymmetrically on the face.

16. The connector as claimed in claim 10, wherein the plug comprises a socket element configured to allow a stacking of several plugs and/or sockets.

17. The connector as claimed in claim 10, wherein the plug further includes a spring ring configured to provide for at least one of a locking mechanism and acknowledgement mechanism of a plugging-in of the connector.

18. The connector as claimed in claim 17, wherein the spring ring bears on balls which are housed in a groove of the socket upon connection.

19. The connector as claimed in claim 10, wherein the socket is fixed to an external device by a fixing element and is connected to the device by contacts interconnecting directly with the device or through an electrical circuit electrically connected to the socket and interfacing with the device.
